(19) United States
(12) Patent Application Publication
(10) Pub. No.: US 2014/0117297 A1
(43) Pub. Date: May 1, 2014

(54) STABILIZER JACK

(71) Applicant: NORCO INDUSTRIES, INC., Compton, CA (US)

(72) Inventor: Bernard F. GARCEAU, Vandalia, OH (US)

(73) Assignee: NORCO INDUSTRIES, INC., Compton, CA (US)

(21) Appl. No.: 13/662,302

(22) Filed: Oct. 26, 2012

(51) Int. Cl. B60S 9/06

(52) U.S. Cl. CPC B60S 9/06
USPC 254/424

(57) ABSTRACT

A stabilizer jack for stabilizing a recreational vehicle includes a channel having longitudinally extending side flanges and an end defining an aperture. A trunnion including a threaded bore is at least partially disposed within the channel for movement along the side flanges. A drive screw extends through the end aperture and engages the threaded bore of the trunnion. A support leg including a foot pad is rotatably connected to the trunnion. A link is hingedly connected to the support leg and the channel.

### BACKGROUND

This invention relates generally to devices for stabilizing vehicles, particularly for recreational vehicles in a parked state.

Many vehicles, including recreational vehicles (RVs) and trailers and the like, incorporate spring suspension systems mounted between the chassis frame and the wheels to provide a smooth ride during transit. These such suspension systems are intended, among other things, to enhance passenger comfort, for example by minimizing vibration and absorbing impacts from sudden changes in the road surface. However, in order to provide vehicle stability to RV's in a parked state, a vehicle stabilizing mechanism is typically employed to limit the vehicle motion, such as rocking fore and aft and/or side to side.

One type of vehicle stabilizing mechanism is the stabilizer jack. Stabilizer jacks are often used to stabilize vehicles such as RVs.

### SUMMARY

A stabilizer jack for stabilizing a vehicle includes a channel having longitudinally extending side flanges and an end defining an aperture. A trunnion including a threaded bore is at least partially disposed within the channel for movement along the side flanges. A drive screw extends through the end aperture and engages the threaded bore of the trunnion. A support leg including a foot pad is rotatably connected to the trunnion. A link is hingedly connected to the support leg and the channel.

Various aspects will become apparent to those skilled in the art from the following detailed description and the accompanying drawings.

### BRIEF DESCRIPTION OF THE DRAWINGS

FIG. 1 is a top perspective view of a stabilizer jack.

FIG. 2 is a is a side view of a portion of the stabilizer jack of FIG. 1.

FIG. 3 is a top perspective view of a blank for forming the mounting channel of FIG. 1.

FIG. 4 is a top perspective view of the mounting channel of FIG. 1.

FIG. 5 is a cross-sectional view of a portion of the mounting channel of FIG. 4 taken along line 5-5.

FIG. 6 is an end view of the mounting channel of FIG. 4.

FIG. 7 is a top perspective view of a blank for forming the support leg of FIG. 1.

FIG. 8 is a top perspective view of the support leg of FIG. 1

FIG. 9 is a cross-sectional view of the support leg of FIG. 8 taken along line 9-9.

FIG. 10 is a cross-sectional view of a portion of the support leg of FIG. 8 taken along line 10-10.

FIG. 11 is a top perspective view of the strut of FIG. 1

FIG. 12 is a top perspective view of a blank for forming a trunnion for the stabilizer jack of FIG. 1.

FIG. 13 is a top perspective view of a trunnion for the stabilizer jack of FIG. 1.

FIG. 14 is an end view of the trunnion of FIG. 13.

FIG. 15 is a side view of the trunnion of FIG. 13.

FIG. 16 is a top perspective view of the foot of FIG. 1

FIG. 17 is a top perspective view of the bracket of FIG. 1.

### DETAILED DESCRIPTION

While the term “recreational vehicle” generally refers to a vehicle with a living space and related amenities, it must be understood that as used herein the term “recreational vehicle” may include a motor vehicle or a trailer. For example, a “recreational vehicle” may be a motor home, a camper, and the like.

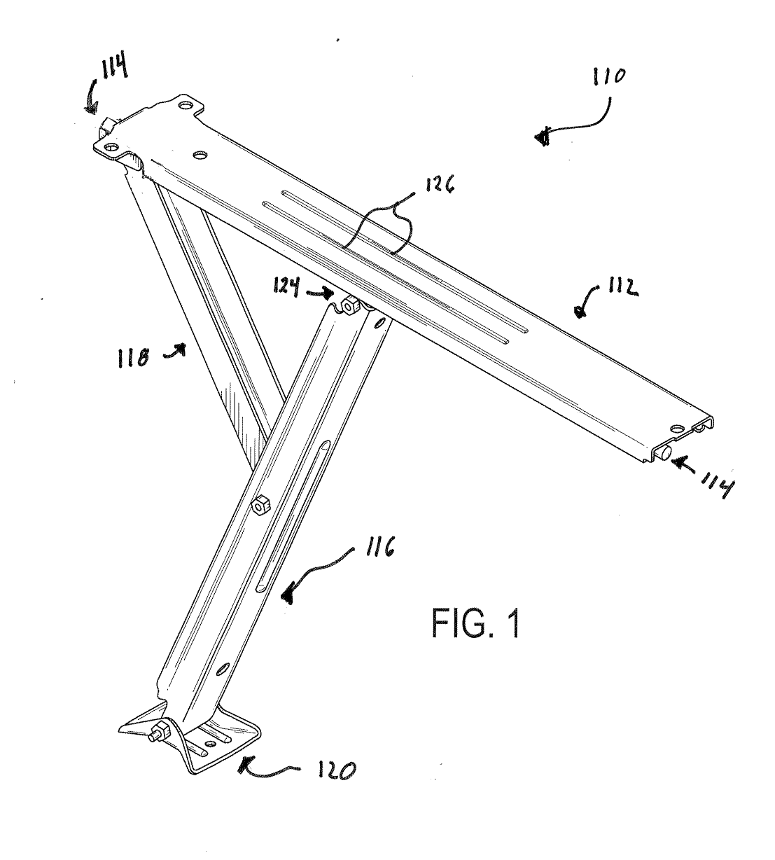

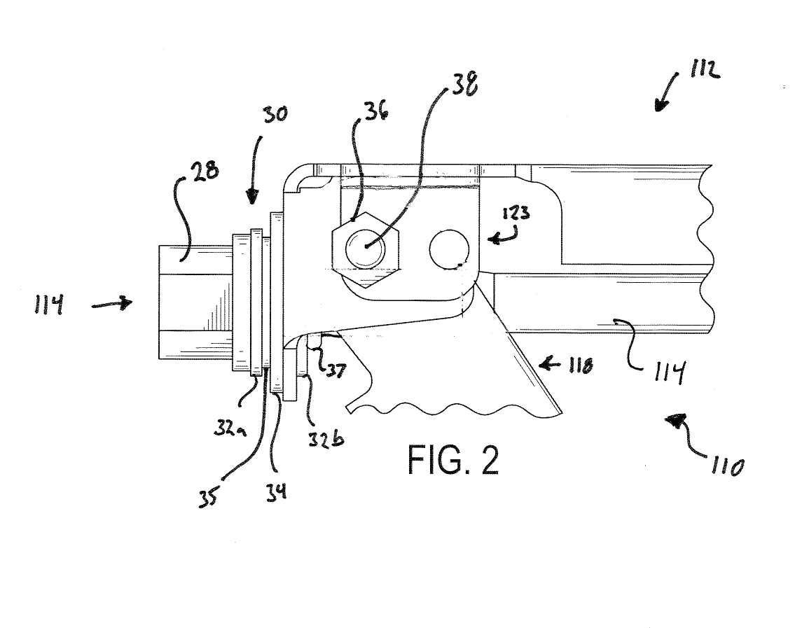

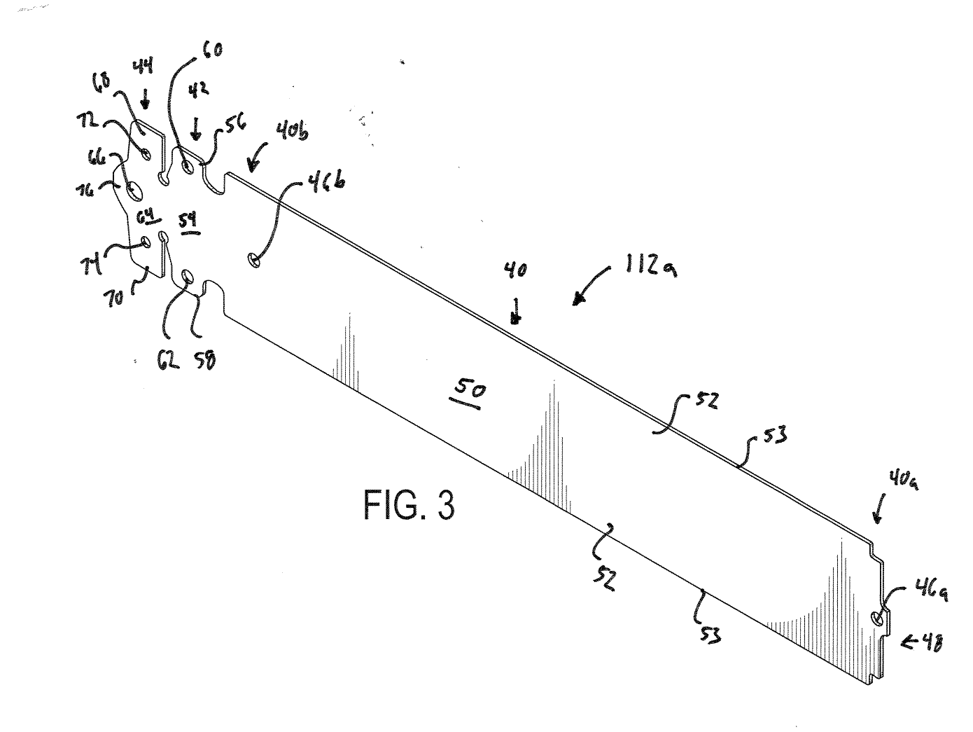

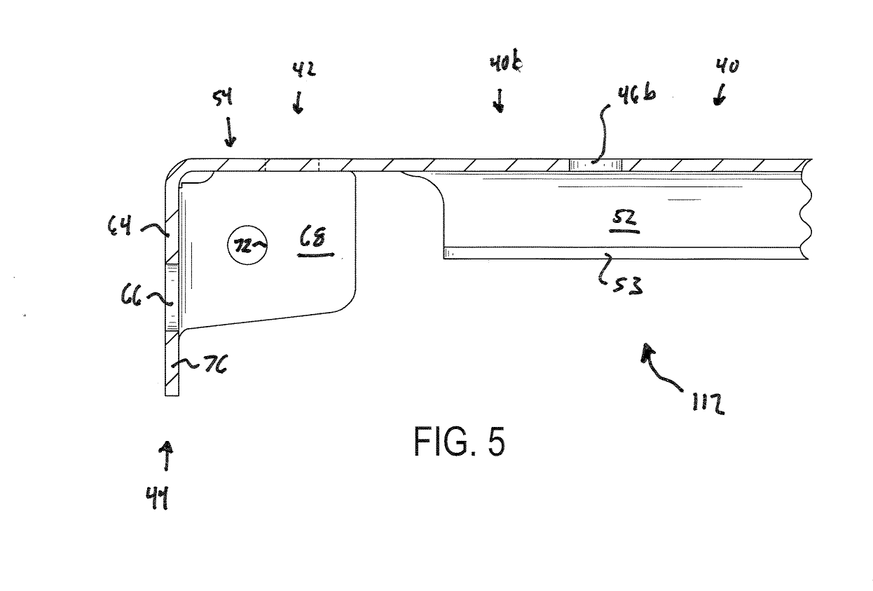

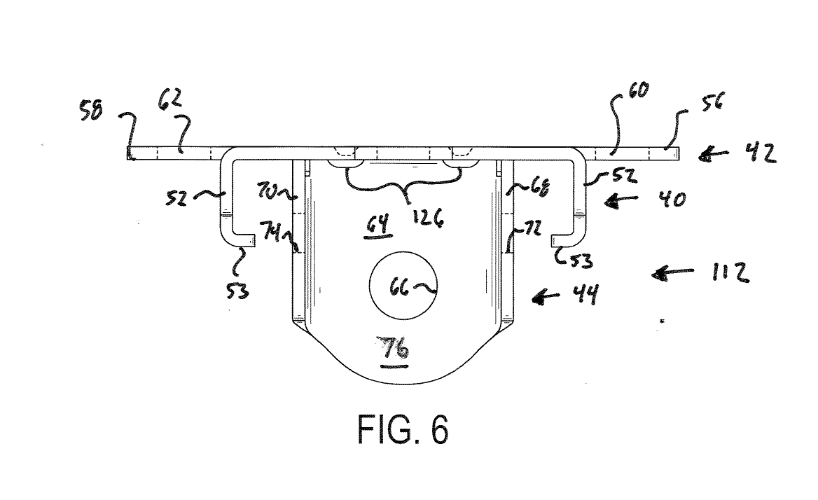

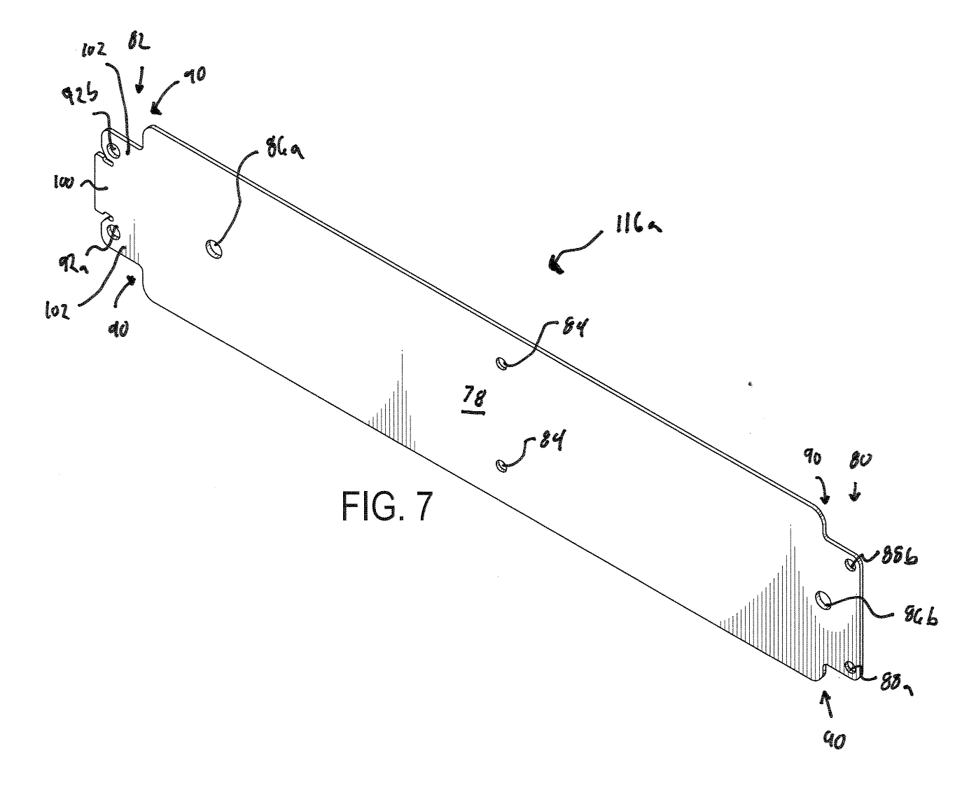

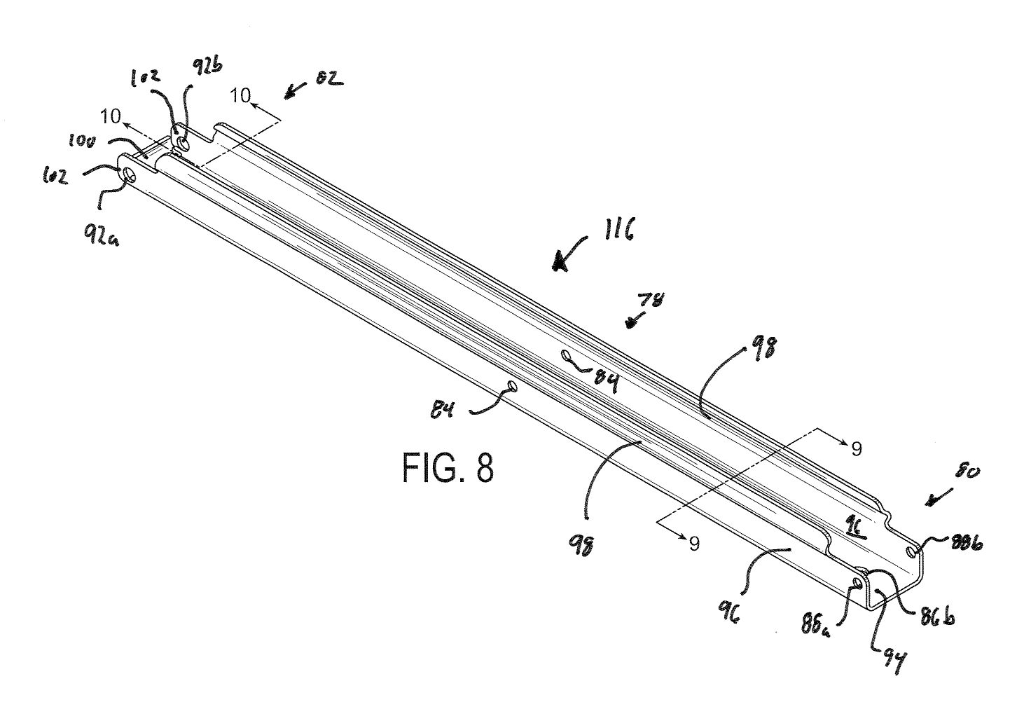

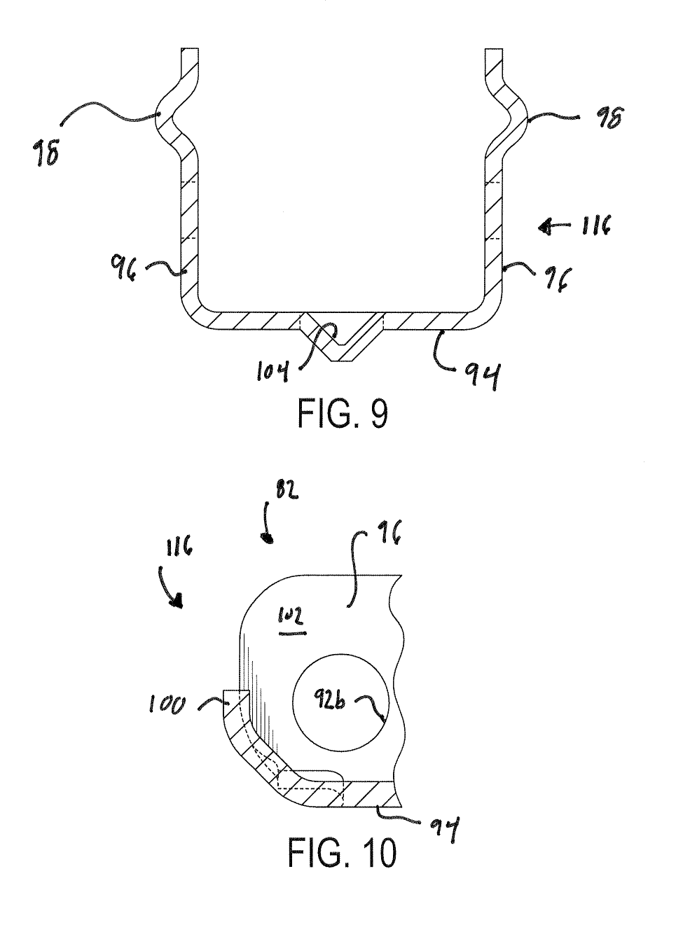

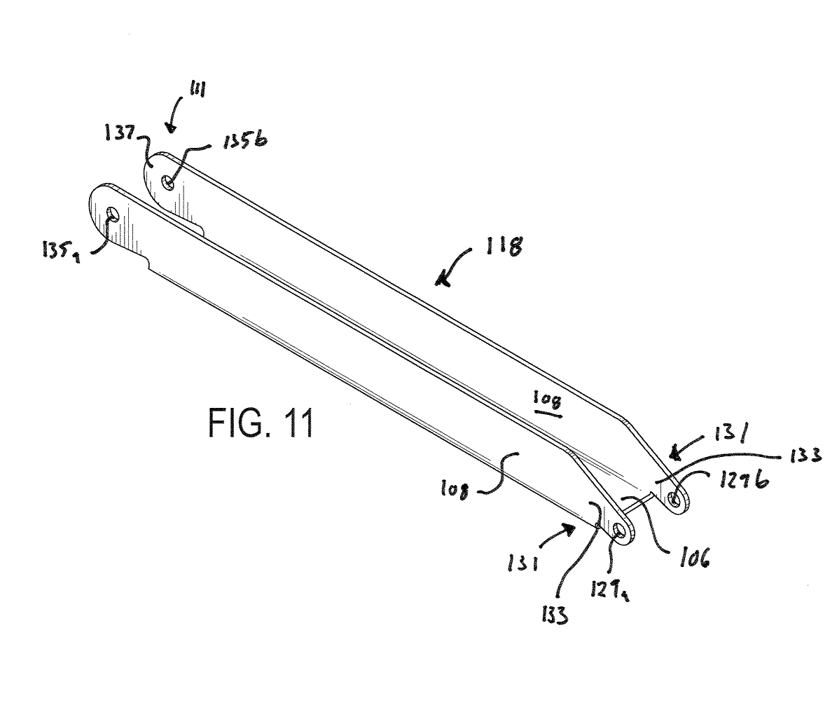

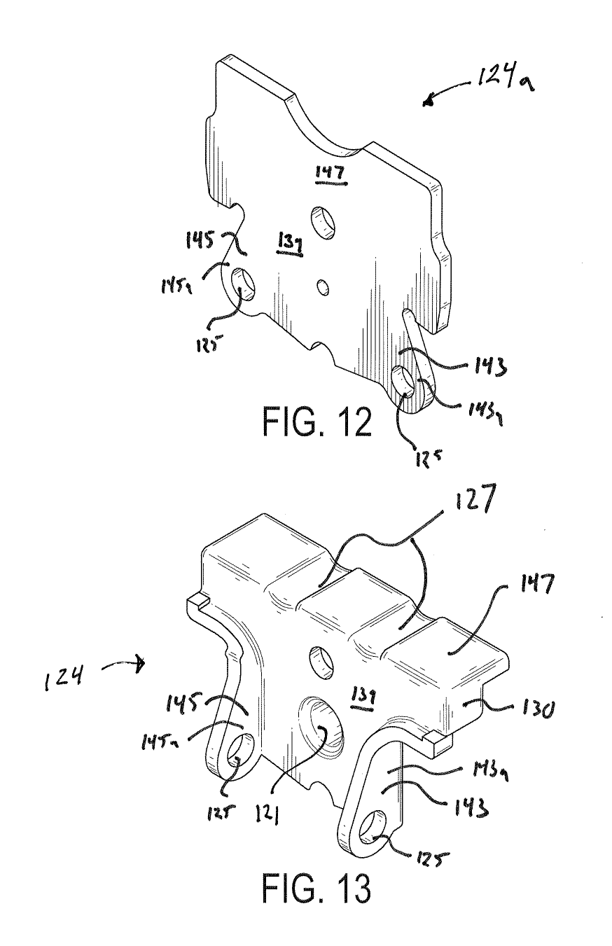

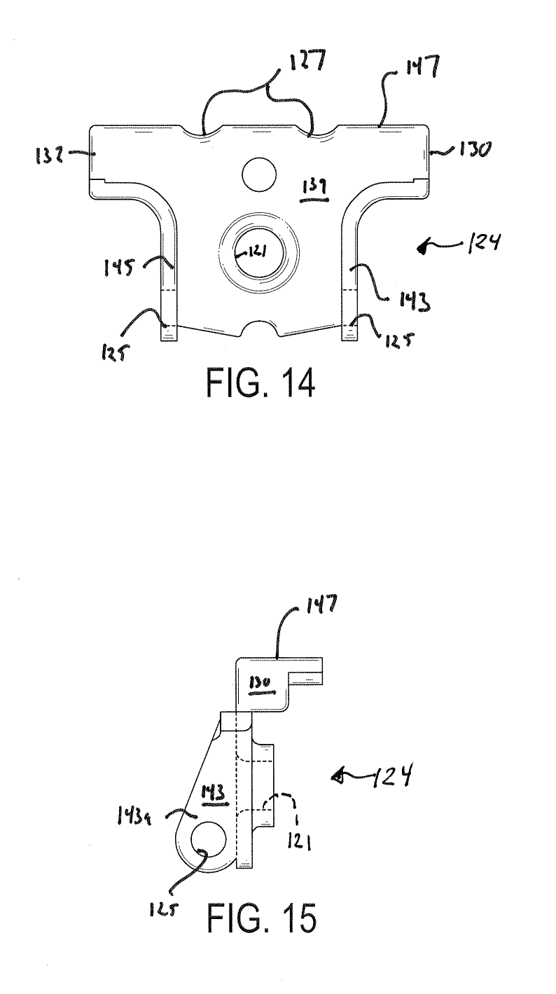

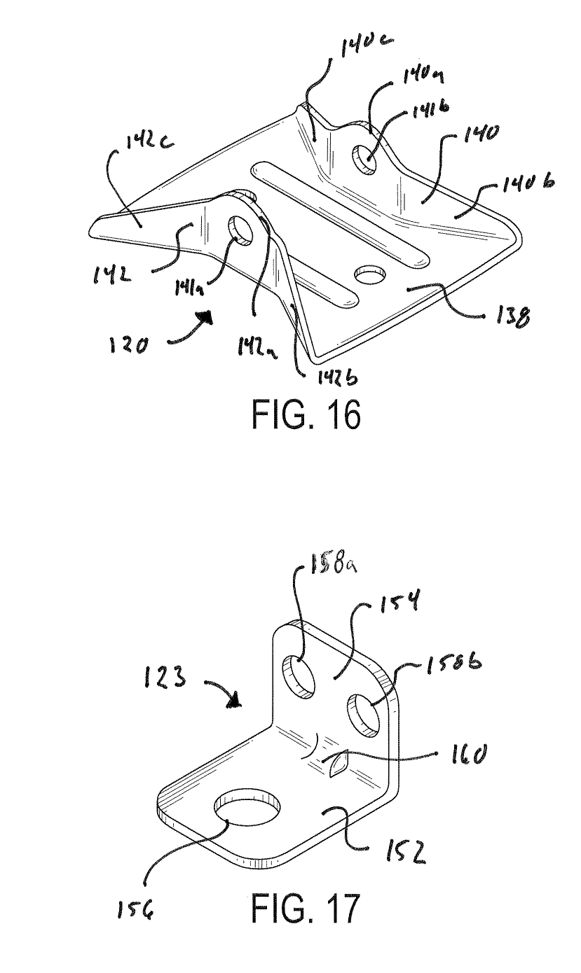

There is illustrated in FIGS. 1 and 2 a stabilizer jack 110 for securement to a recreational vehicle (RV), not shown, for stabilizing the RV while in a parked state. The jack 110 includes a channel 112, as best shown in FIGS. 3-6. A trunnion 124, as best shown in FIGS. 12-15, including a threaded bore 121, is at least partially disposed within the channel 112 for movement there along. A drive screw 114 extends through the channel 112 and engages the threaded bore 121 of the trunnion 124. A support leg 116, as best shown in FIGS. 7-10, with a foot pad 120, as best shown in FIG. 16, rotatably connected there to, is pivotably connected to the trunnion 124. A link 118, as best shown in FIG. 11, is hingedly connected to the support leg 116 and the channel 112.

In the illustrated embodiment, the stabilizer jack 110 includes the channel 112 that is configured for attachment to under surface of a vehicle. The elongated screw 114 extends along the longitudinal length of the channel 112. The stabilizer jack 110 includes a trunnion 124 that slideably engages longitudinally along the channel 112. An upper end of the support leg 116 is rotatably connected to the trunnion 124. The stabilizer jack 110 further includes the link 118 hingedly connected between a portion of the channel 112 and the support leg 116. A foot pad 120, as best shown in FIG. 16, is attached to a lower end of the support leg 116 and is configured to rest against a supporting surface, e.g., a concrete floor, road surface, or other surface suitable to support the stabilizer jack 110.

In the illustrated embodiment, the channel 112 includes two longitudinally extending ridges 126 that engage corresponding saddles 127 in the trunnion 124 for guiding slideable movement, as discussed further below. Alternatively, the channel 112 and the trunnion 124 may include any suitable number of cooperating ridges 126 and saddles 127 so as to provide for guided slideable movement between the two.

FIG. 2 illustrates a cutaway of the stabilizer jack of FIG. 1, further including at least one optional reinforcing bracket 123, also shown in FIG. 17, as will be further discussed below.

In the illustrated embodiment, the elongated screw 114 includes a turning engagement mechanism 28 exemplified as a hex-head bolt, that is used to rotate the elongated screw 114 so that the stabilizer jack 110 can extend and retract. The elongated screw 114 is rotatably supported relative to the channel 112 by a thrust bearing arrangement 30. In one arrangement, the screw 114 longitudinally extends through two bearing washers 32a and 32b, a flat washer 34 and a thrust bearing 35, and then extends longitudinally along the channel 112. The thrust bearing arrangement 30 may be retained in place by an optional clip 37, as for example a hair pin clip. Turing of the screw 114 will drive the trunnion 124 relative to the channel 112 to allowing the stabilizer jack 110 to move between extended and retracted positions.

The link 118 rotatably or pivotally connects to the mounting a portion of the stabilizer jack 110 by a securing mechanism, such as a nut 36 and bolt 38 fastener arrangement, screw, rivet or other suitable securing mechanism, which may include at least one optional washer, as will be further discussed below

In the illustrated embodiment, two reinforcing brackets 123 are securedly attached between two portions of the channel 112 to provide additional strength and rigidity to the stabilizer jack 110, as will be further disused below. Further in the illustrated embodiment, elongated screw 114 is provided on at least a portion of outer circumference with a thread. For example, the elongated screw 114 may have a trapezoidal thread, such as a double lead Acme thread, that continuously extends from one end of the elongated screw 114 and across approximately two-thirds to three-fourths of the length of the elongated screw 114.

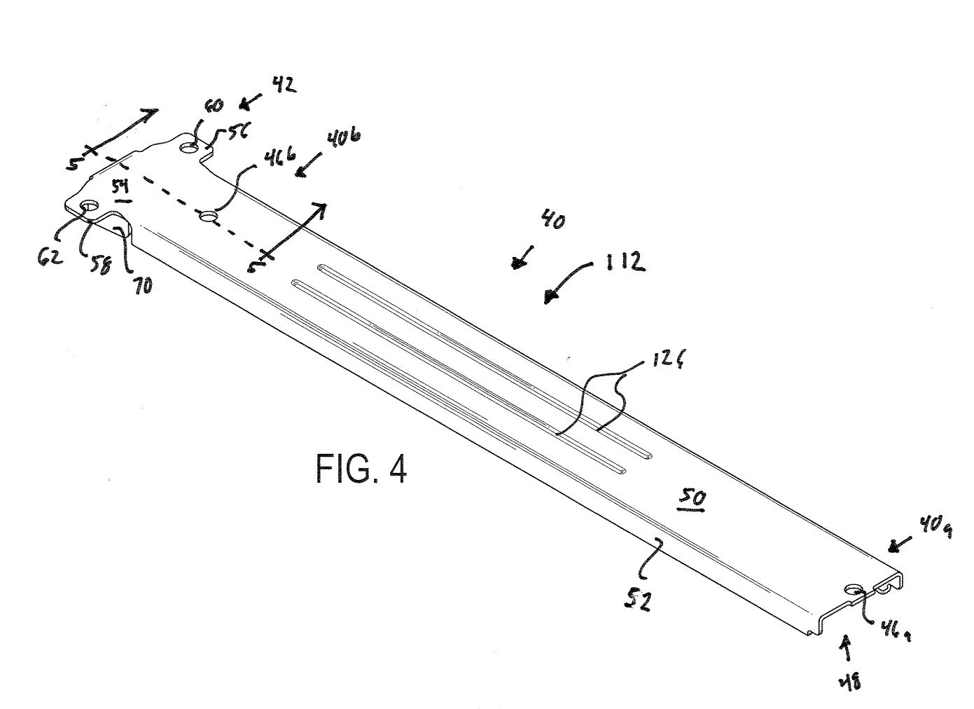

Referring now to FIGS. 3-6 in particular, the channel 112 is illustrated in FIGS. 4-6 and FIG. 5 illustrates a channel flat 112a for the manufacture of the channel 112.

The channel flat 112a is an example of one blank that may be processed in a progressive die or stamp to form the channel 112. The channel flat 112a is preferably made from sheet metal, such as steel or aluminum, and is processed by a progressive die or stamp in a number of steps to form the channel 112 as a monolithic article. Alternatively the channel flat may be made from any other suitable material, such as moldable plastic, such as a thermoplastic.

The channel flat 112a includes a first longitudinal section 40, a second longitudinal section 42, and a third longitudinal section 44. The first longitudinal section 40 is generally rectangular in shape, although such is not required, and includes two apertures 46a and 46b on opposing ends 40a and 40b, respectively. The two apertures 46a and 46b may be used to securedly fasten the stabilizer jack 110 to a recreational vehicle and the like. The first opposing end 40a includes a stepped end 48 that longitudinally extends from the first longitudinal section 40 in a stepped fashion and includes aperture 46a. Further, the first longitudinal section 40 includes an upper longitudinally extending central portion 50 that laterally separates downward extending sides 52. Downward extending sides 52 may also include an optional lower longitudinally extending portion or lip 53.

The second longitudinal section 42 longitudinally extends from the first longitudinal section 40 and includes an upper longitudinally extending central portion 54 that extends from upper longitudinally extending central portion 50. Further, the second longitudinal section 42 includes laterally extending tabs 56 and 58 that have apertures 60 and 62, respectively.

The third longitudinal section 44 includes a central section 64 having a major aperture 66, two laterally extending tabs 68 and 70 each having a minor aperture 72 and 74, respectively, and a convex, longitudinally extending middle portion 76.

The channel 112 has a width extending between the downward extending sides 52 and each side 52 has a height generally associated trunnion 124, as will be discussed further below. The channel 112 includes two longitudinally extending reinforcing ridges 126, which may be formed with corresponding grooves in the upper longitudinally extending central portion 50 of the first longitudinal section 40, although such is not required. The ridges 126 are configured so an upper portion of the trunnion 124 slideably engages the two longitudinally extending ridges 126 that extend from the bottom surface of the upper central portion 50 of the channel 112. The upper longitudinally extending central portion 50, downward extending sides 52, and optional lower longitudinally extending portions 53 form the channel 112 with a c-shaped cross section, although such is not required. In other embodiments, the channel 112 may have any another cross section that allows the trunnion 124 to slideably engage the channel 112.

In the illustrated embodiments, in the formation of the channel 112 from the channel flat 112a, the second longitudinal section 42 is substantially parallel with the upper longitudinally extending central portion 50 of the first longitudinal section 40 and the third longitudinal section 44 is bent beneath the first longitudinal section 40 and the second longitudinal section 42. Specifically, the third longitudinal section 44 is preferably bent downward in a substantially perpendicular fashion so that the central section 64 having the major aperture 66 laterally extends across a lower section of the channel 112. In addition, two laterally extending tabs 68 and 70 are preferably bent towards the first longitudinal section 40 in a substantially perpendicular fashion relative to the central section 64 to finish forming the channel 112 of the stabilizer jack 110. The major aperture 66 receives the bearing arrangement 30 and therethrough the elongated screw 114. The two laterally extending tabs 68 and 70 each having a minor aperture 72 and 74, respectively, may be securedly connected to the apertures in the bracket 123.

The laterally extending tabs 56 and 58 having apertures 60 and 62, respectively, extend laterally outside of an adjacent downward extending side 52 and lower longitudinally extending portion 53. The major aperture 66 and the convex, downward extending middle portion 76 extend below the downward extending sides 52 and lower longitudinally extending portions 53. As discussed above, the two laterally extending tabs 68 and 70 are bent towards the first longitudinal section 40 in a substantially perpendicular fashion relative to the central section 64.

Referring now to FIGS. 7-10 in particular, the leg 116 is illustrated in FIGS. 8-10 and FIG. 7 illustrates a leg flat 116a for the manufacture of the leg 116.

The leg flat 116a may be processed in a progressive die or stamp to form the support leg 116 in a monolithic fashion, similarly to the channel flat 112a above to form the channel 112. In the illustrated embodiments, the leg flat 116a includes a central longitudinal section 78, a first end section 80, and a second end section 82. The central longitudinal section 78 includes a major aperture 86a. The central longitudinal section 78 also includes two minor apertures 84 that are configured to securedly connect to the link 118 (discussed above and below). The first end section 80 includes a major aperture 86b. The first end section 80 also includes two minor apertures 88a-b that securedly connect to the trunnion 124 (discussed above and below). The central longitudinal section 78 and the first end section 80 and second end section 82 have different lateral widths where the transition between the lateral widths form curvilinear edges 90 between each section when the support leg 116 is formed. Further, the second end section 82 includes two intermediate apertures 92a-b that securedly connect to the foot pad 120 (discussed above and below).

The support leg 116 includes a lower longitudinally extending section 94, and two upward extending sides 96. The support leg 116 includes at least one optional longitudinally extending reinforcing furrow 98 or formed groove to reinforce the support leg 116 in the lower longitudinally extending section 94. In the illustrated embodiments, the upward extending sides include at least one optional longitudinally extending reinforcing furrow 98 or formed groove that reinforces the support leg 116 and the one minor aperture 84 about midway along the longitudinal length of the support leg 116 where the support leg 116 connects to the link. In the illustrated embodiments, the one minor aperture 84 is offset from the longitudinally extending reinforcing furrow 98, although such is not required. As discussed above, the two minor apertures 88a-b on the first end section 80 securedly connect the support leg 116 to the trunnion and the two intermediate apertures 92a-b on the second end section 82 connect the support leg to the foot pad 120. In the illustrated embodiments, the second end section 82 forms into a longitudinally extending curved reinforcement 100 and two laterally separated longitudinally extending sides 102 that forms a reinforcement that fits into a mid section of the foot pad 120.

The longitudinal extending side 102 is illustrated as longitudinally extending to a middle portion of the curved reinforcement 100, whereas the curved reinforcement 100 laterally separates the two longitudinal extending sides 102, although such is not required. The support leg 116 may be made from metals, similar to the parts identified previously. Alternatively, the support leg 116 may be made from plastic, as discussed above.

FIG. 11 illustrates a perspective view of one embodiment of the link 118. The link 118 has a c-shaped cross section, although such is not required. The link 118 includes a longitudinally extending section 106 and two upward extending longitudinally extending sides 108. The longitudinally extending sides 108 each have a first end 131 having a first aperture 129a-b in an angled end 133 that securedly connects to the support leg 116 and a second end 111 having a second aperture 135a-b in a curved end 137 that securedly connects to the channel 112. The angled end 133 slopes at about a thirty degree angle relative to a plane that extends from and that is parallel with the longitudinally extending sides. In another embodiment, the angled end slopes between ten and sixty degrees. In another embodiment, the link may include longitudinally extending reinforcing furrows or formed grooves. In the illustrated embodiment, the two upward extending longitudinally extending sides 108 have a height that accommodates the passage of the elongated screw along its longitudinal length. Further, the longitudinally extending section 106 does not extend to the second apertures 129a-b to accommodate the passage of the elongated screw as the link 118 pivots relative to the mounting a portion of the stabilizer jack 110. In the illustrated embodiment, the link 118 is made from metals identified previously. In another embodiment, the link may be made from plastic, including the plastic materials discussed above.

Referring now to FIGS. 12-15 in particular, the trunnion 124 is illustrated in FIGS. 13-15 and FIG. 12 illustrates a trunnion flat 124a for the manufacture of the trunnion 124.

The trunnion flat 124a may be processed in a progressive die or stamp to form the trunnion 124, as a monolithic trunnion. The trunnion 124 includes a vertically extending first face 139 that laterally separates two vertically extending curvilinear flanges 143 and 145. The two vertically extending curvilinear flanges 143 and 145 include a vertically extending face 143a and 145a, respectively, each having an aperture 125 that securedly connects to apertures 88a-b in the support leg 116. The trunnion 124 further includes a laterally extending second surface 147 that longitudinally extends from the vertically extending first face 139. The laterally extending second surface 147 includes at least one longitudinally extending saddle 127 that slideably engages the at least one longitudinally extending ridge 126 the channel 112 (discussed above). Further, the trunnion 124 further includes a first laterally extending side surface 130 and a second laterally extending side surface 132. The laterally extending second surface 147, the first laterally extending side surface 130, and the second laterally extending side surface 132 are slidably carried by the channel having a c-shaped cross section (discussed above). Further, the trunnion 124 includes the 121 that is threaded, for example with a double lead Acme thread, that is dimensionally compatible with the threading provided on the threaded portion of the elongated screw 114 so that it threadably engages the elongated screw 114 so that the trunnion 124 longitudinally moves along the c-shaped cross section of the channel 112 as the elongated screw 114 is rotated. The trunnion 124 is made from metals identified previously. Alternatively, the trunnion 124 may be made from plastic, including the plastic materials discussed above.

Referring to FIG. 16, the foot pad 120, which may be produced in a progressive die or stamp from a foot pad flat (not shown), similarly as described above, includes a base 138 and vertically extending sidewalls 140 and 142. The sidewalls 140 and 142 each include a main central upward extending portion that has a convex end 140a and 142a, respectively, each having a primary aperture 141a-b that securedly connects to the support leg 116 via a fastening mechanism. The base 138 is generally perpendicular to upward extending portions 140a and 142a, and the upward extending portions 140a and 142a are preferably generally parallel to facilitate assembly with the support leg 116. The sidewall 140 includes first and second longitudinally extending portions 140b and 140c, respectively, that have downward sloping upper edges and that longitudinally extend away from upward extending portion 140a. Similarly, the sidewall 142 includes first and second longitudinally extending portions 142b and 142c, respectively, that have downward sloping upper edges and that longitudinally extend away from upward extending portion 142a. The foot pad 120 may be made from metals identified previously. Alternatively, the foot pad 120 may be made from plastic, including the plastic materials discussed above.

Regarding FIG. 17, the reinforcement bracket 123, which may be formed from a bracket flat, similarly as discussed above, includes a first portion 152 and a second portion 154 that are substantially perpendicular to one another. The lower portion 152 includes a major aperture 156 configured to securedly connect to the longitudinally extending tabs 56 or 58 when attached to a vehicle. The upper portion 154 includes two minor apertures 158a and 158b configured to securedly connect to at least one to laterally extending tabs 68 or 70 with a fastening mechanism. The reinforcement bracket 123 also includes a reinforcing gusset 160 at the transition of the first portion 152 and the second portion 154. The reinforcement bracket 150 may be made from metals identified previously. Alternatively, the reinforcement bracket may be made from plastic, including the plastic materials discussed above.

In one use, at least one stabilizer jack 110 may be used on at least one of four corners of a recreational vehicle to provide stabilizing support when the recreational vehicle is not moving. Further, the stabilizer jack may be used on other types of vehicles.

In operation, the stabilizer jack 110 will support a load in contact with the channel 112. The jack 110 may be extended or contracted when a rotation causing tool causes the elongated screw 114 to rotate within the threaded aperture of the trunnion 124 in a direction that will cause the trunnion 124 to be drawn along the threaded portion toward of the screw 114. During one typical use, the stabilizer jack 110 may be fixedly positioned on the underneath of a vehicle and put into the contracted state for travel and put into the extended state when parked.

While principles and modes of operation have been explained and illustrated with regard to particular embodiments, it must be understood, however, that this may be practiced otherwise than as specifically explained and illustrated without departing from its spirit or scope.

What is claimed is:

1. A stabilizer jack for securement to a recreational vehicle comprising:
a monolithic channel for attachment to a recreational vehicle, the channel having first and second longitudinally extending side flanges and a proximal end defining an aperture;
a monolithic trunnion at least partially disposed within the channel, the trunnion including a threaded bore, and having laterally extending bearing portions engaging the first and second side flanges for movement along the channel;
a drive screw extending through the end aperture for rotational movement therein and engaging the threaded bore of the trunnion;
a support leg having first and second ends, the support leg pivotably connected to the trunnion at the first end and including a foot pad at the second end; and
a link hingedly connected to the support leg and the channel.

2. The stabilizer jack of claim 1 where the channel further has first and second laterally extending tabs adjacent the proximal end.

3. The stabilizer jack of claim 2 where the channel further has first and second longitudinally extending tabs adjacent the proximal end.

4. The stabilizer jack of claim 3 further comprising a first bracket extending between the first laterally extending tab and the first longitudinally extending tab and further comprising a second bracket extending between the second laterally extending tab and the second longitudinally extending tab.

5. The stabilizer jack of claim 1, further comprising a thrust bearing arrangement disposed in the aperture and supporting the drive screw relative to the channel.

6. The stabilizer jack of claim 1 where the channel further has at least one downwardly extending ridge.

7. The stabilizer jack of claim 6 where the trunnion includes an upper surface defining at least one saddle for cooperation with the at least one ridge to assist in guiding the trunnion in movement along the channel.

8. The stabilizer jack of claim 1 where the trunnion further includes a vertically extending face between the first and second laterally extending bearing portions and also includes first and second laterally extending flanges extending from opposite sides of the vertically extending face proximate the first and second laterally extending bearing portions respectively

9. The stabilizer jack of claim 8 where the leg is pivotally attached to the trunnion at the first and second laterally extending flange.

10. A stabilizer jack for securement to a recreational vehicle comprising:
a channel for attachment to a recreational vehicle, the channel having first and second longitudinally extending side flanges and a proximal end defining an aperture;
a monolithic trunnion at least partially disposed within the channel, the trunnion including a threaded bore, and having laterally extending bearing portions engaging the first and second side flanges for movement along the channel;
a drive screw extending through the end aperture for rotational movement therein and engaging the threaded bore of the trunnion;
a support leg having first and second ends, the support leg pivotably connected to the trunnion at the first end and including a foot pad at the second end; and
a link hingedly connected to the support leg and the channel.

11. The stabilizer jack of claim 10 where the channel further has first and second laterally extending tabs adjacent the proximal end.

12. The stabilizer jack of claim 11 where the channel further has first and second longitudinally extending tabs adjacent the proximal end.

13. The stabilizer jack of claim 12 further comprising a first bracket extending between the first laterally extending tab and the first longitudinally extending tab and further comprising a second bracket extending between the second laterally extending tab and the second longitudinally extending tab.

14. The stabilizer jack of claim 10, further comprising a thrust bearing arrangement disposed in the aperture and supporting the drive screw relative to the channel.

15. The stabilizer jack of claim 10 where the channel further has at least one downwardly extending ridge.

16. The stabilizer jack of claim 15 where the trunnion includes an upper surface defining at least one saddle for cooperation with the at least one ridge to assist in guiding the trunnion in movement along the channel.

17. The stabilizer jack of claim 10 where the trunnion further includes a vertically extending face between the first and second laterally extending bearing portions and also includes first and second laterally extending flanges extending from opposite sides of the vertically extending face proximate the first and second laterally extending bearing portions respectively

18. The stabilizer jack of claim 17 where the leg is pivotally attached to the trunnion at the first and second laterally extending flange.

19. A stabilizer jack for securement to a recreational vehicle comprising:
a monolithic channel for attachment to a recreational vehicle, the channel having first and second longitudinally extending side flanges and a proximal end defining an aperture;
a trunnion at least partially disposed within the channel, the trunnion including a threaded bore, and having first and second laterally extending bearing portions respectively engaging the first and second side flanges for movement along the channel;
a drive screw extending through the end aperture for rotational movement therein and engaging the threaded bore of the trunnion;
a support leg having first and second ends, the support leg pivotably connected to the trunnion at the first end and including a foot pad at the second end; and
a link hingedly connected to the support leg and the channel.

20. The stabilizer jack of claim 19 where the channel further has first and second laterally extending tabs adjacent the proximal end.

21. The stabilizer jack of claim 20 where the channel further has first and second longitudinally extending tabs adjacent the proximal end.

22. The stabilizer jack of claim 21 further comprising a first bracket extending between the first laterally extending tab and the first longitudinally extending tab and further comprising a second bracket extending between the second laterally extending tab and the second longitudinally extending tab.

23. The stabilizer jack of claim 19, further comprising a thrust bearing arrangement disposed in the aperture and supporting the drive screw relative to the channel.

24. The stabilizer jack of claim 19 where the channel further has at least one downwardly extending ridge.

25. The stabilizer jack of claim 24 where the trunnion includes an upper surface defining at least one saddle for cooperation with the at least one ridge to assist in guiding the trunnion in movement along the channel.

26. The stabilizer jack of claim 19 where the trunnion further includes a vertically extending face between the first and second laterally extending bearing portions and also includes first and second laterally extending flanges extending from opposite sides of the vertically extending face proximate the first and second laterally extending bearing portions respectively

27. The stabilizer jack of claim 26 where the leg is pivotally attached to the trunnion at the first and second laterally extending flange.
